(19) United States
(12) Patent Application Publication
(10) Pub. No.: US 2005/0221809 A1
(43) Pub. Date: Oct. 6, 2005

(54) METHOD FOR INFORMING A MOBILE PHONE OF A TRANSFERRED INCOMING CALL

(76) Inventor: Yu-Sheng LIN, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/907,445

(22) Filed: Apr. 1, 2005

(30) Foreign Application Priority Data
Apr. 6, 2004 (TW) 093109489

(51) Int. Cl. H04M 3/42

(52) U.S. Cl. 455/418; 455/417

(57) ABSTRACT

A method for informing a mobile phone in a telecommunication system a transferred incoming call includes receiving a command for setting the incoming call of the mobile phone to transfer to a first phone, transferring the incoming call to the first phone and recording the incoming call information in an incoming call message by the telecommunication system when the mobile phone receives the incoming call, and sending the incoming call message to the mobile phone.

### BACKGROUND OF INVENTION

1. Field of the Invention

The present invention relates to a method for informing a mobile phone of a transferred incoming call and more particularly, to a method for informing a mobile phone of the detail of a transferred incoming call.

2. Description of the Prior Art

Incoming call transfer is a popular function of telecomms services nowadays. It can provide a client with the ability to transfer an incoming call to a predetermined phone number. For example, the client can transfer an incoming call from a mobile phone to a landline telephone so as to reduce the unhealthy effects associated with mobile phones. Furthermore, when the mobile phone can not answer the incoming call due to being busy, no signal response, and so on, the incoming call can be transferred to another phone instead.

However it has often been seen that users set the transfer telecom service and forget to cancel the service later when they do not need the service anymore. Hence following calls may be missed due to being continually transferred without the user being conscious of the problem. Moreover the client can not get the information of the transferred incoming call, such as an incoming call time, a incoming call number, or whether the incoming call is transferred and answered. The above factors lead to a very inconvenient situation for telecom clients.

### SUMMARY OF INVENTION

It is therefore a primary objective of the claimed invention to provide a method for informing a mobile phone of a transferred incoming call for solving the above-mentioned problem.

According to the claimed invention, a method for informing a mobile phone in a telecommunication system of a transferred incoming call includes receiving a command for setting the incoming call of the mobile phone to transfer to a first phone, transferring the incoming call to the first phone and recording the incoming call information in an incoming call message by the telecommunication system when the mobile phone is called by the incoming call, and sending the incoming call message to the mobile phone.

According to the claimed invention, a method for informing a mobile phone in a telecommunication system of a transferred incoming call, includes sending a command to the telecommunication system for setting an incoming call of the mobile phone to transfer to a first phone and recording the incoming call information in an incoming call message, and receiving the incoming call message.

According to the claimed invention, a telecommunication system for informing a mobile phone of a transferred incoming call includes a storage unit, a base station for communicating with the mobile phone, and a logic unit for transferring the incoming call of the mobile phone to a first phone, recording an incoming call message in the storage unit, and controlling the base station to transmit the incoming call message.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a telecommunication system according to the present invention.

FIG. 2 is a flowchart illustrating a service end informing a mobile phone of a transferred incoming call.

### DETAILED DESCRIPTION

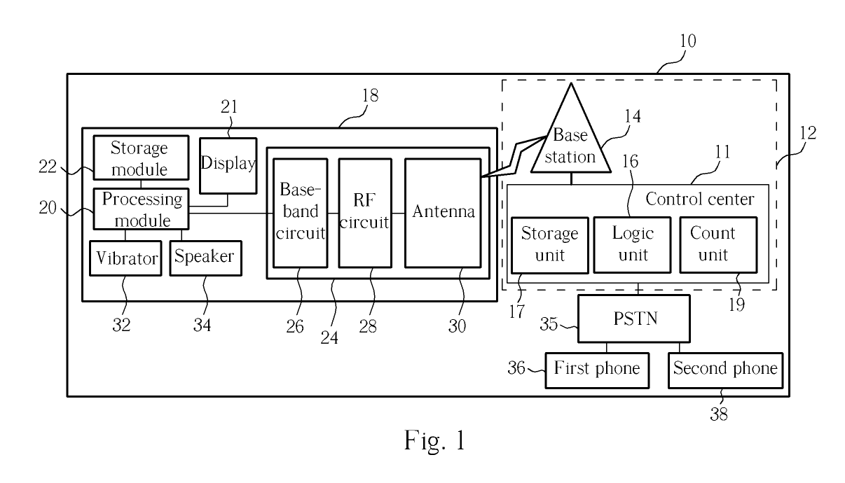

Please refer to FIG. 1 . FIG. 1 is a functional block diagram of a telecommunication system 10 according to the present invention. The telecommunication system 10 can be any kind of telecommunication systems for a mobile phone, such as GSM or PHS. The telecommunication system 10 includes a service end 12 for providing a telecom service for clients. The service end 12 includes a base station 14 for transmitting and receiving radio signals, and a control center 11 for controlling the service end 12. The control center 11 includes a logic unit 16, a storage unit, and a count unit 19. The telecommunication system 10 further includes a mobile phone 18 capable of communicating with the service end 12 while within a service transmission range. The mobile phone 18 includes a processing module 20 for controlling the mobile phone 18, and a storage module 22 for storing data of the mobile phone 18, such as a calendar recording a start time and an ending time for transferring incoming calls. The mobile phone 18 further includes a wireless communication module 24, which includes a baseband circuit 26, an RF circuit 28, and an antenna 30. The processing module 20 can process the data, then transmit the processed communication signals to the baseband circuit 26. The baseband circuit 26 can encode the communication signals from the processing module 20 into baseband signals, then transmit them to the RF circuit 28. The RF circuit 28 modulates the baseband signals into RF signals and transmits them through the antenna 30. The RF circuit 28 can also receive RF signals through the antenna 30 and demodulate them into baseband signals. The baseband circuit 26 then decodes the baseband signals into communication signals and transmits them to the processing module 20. The mobile phone 18 further includes a vibrator 32, a display 21, and a speaker 34 for informing users of an incoming call to the mobile phone 18. The telecommunication system 10 further includes a public switched telephone network (PSTN) 35, a first phone 36, and a second phone 38, such as a mobile phone or a local telephone.

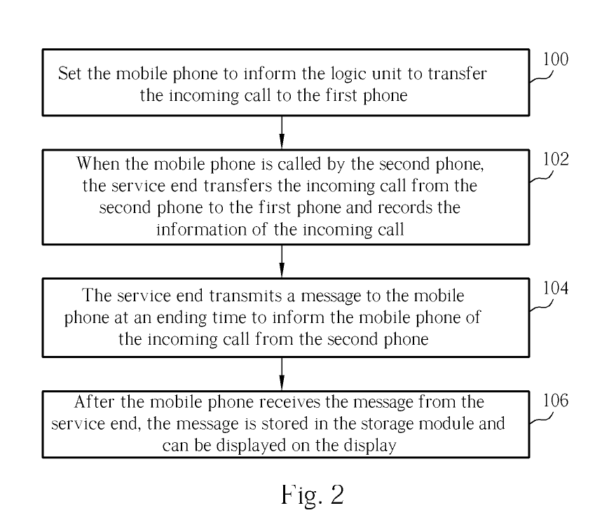

Please refer to FIG. 2. FIG. 2 is a flowchart illustrating the service end 12 informing the mobile phone 18 of a transferred incoming call. The method includes the following steps:

Step 100: Set the mobile phone 18 to inform the logic unit 16 to transfer the incoming call to the first phone 36. The setting can include the transfer destination, the start time of the transfer, the ending time of the transfer, and so on.

Step 102: After Step 100, when the mobile phone 18 is called by the second phone 38, the service end 12 transfers the incoming call from the second phone 38 to the first phone 36 via the PSTN 35 and records the information of the incoming call as an incoming call message 171 in the storage unit 17. The incoming call message 171 can include the phone number, the time, or the source of the incoming call, and so on.

Step 104: The service end 12 transmits a message including the incoming call message 171 to the mobile phone 18 at an ending time to inform the mobile phone 18 of the incoming call information from the second phone 38. The count unit counts the ending time.

Step 106: After the mobile phone 18 receives the message from the service end 12, the message is stored in the storage module 22 and can be displayed on the display 21.

First a user can set incoming calls to the mobile phone 18 to be transferred to the first phone 36. The setting can include the transfer destination, the start time of the transfer, the ending time of the transfer, and so on. The mobile phone 18 can be set to transfer incoming calls when the incoming call occurs during a period specified by the calendar stored in the storage module 22. Alternatively, the mobile phone 18 can be set to transfer incoming calls at a start time corresponding to the mobile phone 18 sending a command to the base station 14 to confirm the phone number of the destination phone, and an ending time of the transfer. At this time, the mobile phone 18 can transmit the setting of the transfer to the base station 14 of the server end 12 via the wireless communication module 24, and then transmit it to the control center 11 for setting the transfer service for the mobile phone 18. The transfer conditions can be: transferring the incoming call to the first phone 36 unconditionally, transferring the incoming call to the first phone 36 when the mobile phone 18 is busy, transferring the incoming call to the first phone 36 when the wireless communication module 24 of the mobile phone 18 can not receive radio signals, or transferring the incoming call to the first phone 36 when the incoming call occurs during a first period of the calendar. The first period can be from a certain time point to another time point, such as from midday on a particular (or every) Friday, to eight a.m. the following (or every) Monday, every Thursday, and so on. The first phone 36 can be a mobile phone or a landline phone.

After setting the transfer function of the mobile phone 18, the logic unit 16 of the control center 11 will transfer an incoming call from the second phone 38 to the first phone 36 via the PSTN 35, and store the incoming call message 171 in the storage unit 17 when the mobile phone 18 is called by the second phone 38.

After the control center 11 transfers the incoming call of the second phone 38 to the first phone 36 and the call is terminated, the logic unit 16 of the service end 12 will control the base station 14 to send a message to the wireless communication module 24 of the mobile phone 18, to inform the user of the incoming call information of the second phone 38 immediately, or at an ending time in the first period of the calendar. The message can include the incoming call time of the second phone 38, the communication period, the phone number of the second phone 38, the information regarding whether the incoming call of the second phone 38 is answered by the first phone 36, and so on. Furthermore, if the message is sent out at the ending time in the first period, the message can include all of the incoming call messages 171 during the first period. That is, all of the incoming call messages 171 can be transmitted to the mobile phone 18 at the ending time in the first period, and all of the incoming call messages 171 can be temporarily stored in the storage unit 17 of the control center 11 during the first period.

After the mobile phone 18 receives the message from the service end 12, the processing module 20 can store the message in the storage module 22, and the message can be a word message or can be transferred into a relative communication record. For example, the phone number of the second phone 38 can be stored in an answered phone book or an unanswered phone book according to whether the incoming call of the second phone 38 is answered by the first phone 36, and the phone number is arranged in chronological order. The message transmitted from the service end 12 can follow the message standard of the European Telecommunications Standards Institute (ETSI), and the mobile phone 18 can transfer the message into a relative communication record and store it in the storage module 22 after receiving the message. Even if the mobile phone 18 cannot receive the message due to being out of range or switched off, the stored message will still be received by the mobile phone 18 as soon as the phone comes within receiving range of an active network cell, or is switched on.

In addition, after the mobile phone 18 receives the message from the service end 12, the processing module 20 of the mobile phone 18 can control the vibrator 32 or the speaker 32 to alert the user to the message on the display 21.

Compared to the conventional telecommunication system, the telecommunication system according to the present invention allows the client to receive all incoming call information during the transfer period. Furthermore, the mobile phone can transfer the message including the incoming call information transmitted from the service end of the telecommunication system to the relevant communication record of the mobile phone. If clients forget to cancel the transfer service when no longer required, the message can act as a reminder. In conclusion, the present invention combines the transfer service, the message service, and the phone book of the mobile phone so that the transferred incoming call information can be presented in the original (i.e. unmodified) mobile phone. The present invention not only provides client convenience, but also increases the service quality of the telecommunication service provider.

Those skilled in the art will readily observe that numerous modifications and alterations of the device may be made while retaining the teachings of the invention. Accordingly, the above disclosure should be construed as limited only by the metes and bounds of the appended claims.

1. A method for informing a mobile phone in a telecommunication system of a transferred incoming call comprising:
receiving a command for setting the incoming call of the mobile phone to transfer to a first phone;
transferring the incoming call to the first phone and recording the incoming call information in an incoming call message by the telecommunication system when the mobile phone receives the incoming call; and
sending the incoming call message to the mobile phone.

2. The method of claim 1, wherein the command comprises a first phone number relative to the first phone and an ending time, further comprising:
recording a second phone number and an incoming call time of the incoming call in the incoming call message when the mobile phone receives the incoming call; and
sending the incoming call message to the mobile phone when the ending time occurs.

3. The method of claim 2, wherein the mobile phone comprises a calendar recording a period comprising a start time and the ending time relative to the first phone number, the method further comprising:
receiving the command at the start time.

4. The method of claim 1 wherein the telecommunication system transfers the incoming call to the first phone when the mobile phone is busy or cannot be connected.

5. A method for informing a mobile phone in a telecommunication system of a transferred incoming call comprising:
sending a command to the telecommunication system for setting an incoming call of the mobile phone to transfer to a first phone and recording the incoming call information in an incoming call message; and
receiving the incoming call message.

6. The method of claim 5 further comprising:
storing the incoming call message in the mobile phone; and
informing a user of the incoming call message by ringing the mobile phone, vibrating the mobile phone, or displaying a message on a display of the mobile phone.

7. The method of claim 5, wherein the command comprises a first phone number relative to the first phone and an ending time, further comprising:
sending the incoming call message comprising a second phone number relative to the incoming call and an incoming call time to the mobile phone when the ending time occurs.

8. The method of claim 7, wherein the mobile phone comprises a calendar recording a period comprising a start time and the ending time relative to the first phone number, further comprising:
sending the command at the start time.

9. The method of claim 5 wherein the mobile phone receives the incoming call message in a message format of the mobile phone.

10. A telecommunication system for informing a mobile phone of transferring an incoming call comprising:
a storage unit;
a base station for communicating with the mobile phone; and
a logic unit for transferring the incoming call of the mobile phone to a first phone, recording an incoming call message in the storage unit, and controlling the base station to transmit the incoming call message.

11. The telecommunication system of claim 10 wherein the mobile phone comprises a storage module for storing the incoming call message transmitted from the base station.

12. The telecommunication system of claim 11 wherein the incoming call message comprises an incoming call time, a telephone number of the incoming call, and the information of the incoming call answered by the first phone.

13. The telecommunication system of claim 10 wherein the mobile phone comprises a calendar recording a first period and when the incoming call is during the first period, the mobile phone transfers the incoming call to the first phone.

14. The telecommunication system of claim 10 wherein the base station transmits the incoming call message in a message format of the mobile phone.

15. The telecommunication system of claim 10 further comprising a count unit for counting a predetermined time and the base station transmitting the incoming call message when the predetermined time occurs.
